(19) United States
(12) Patent Application Publication
(10) Pub. No.: US 2003/0234901 A1
(43) Pub. Date: Dec. 25, 2003

(54) Liquid crystal display with wide viewing angle and high brightness uniformity

(75) Inventors: Seok Lyul Lee, Tao-Yuan Hsien (TW); Ming-Tien Lin, Taipei Hsien (TW); Kei-Hsiung Yang, Tao-Yuan Hsien (TW); Ching-Chao Chang, Taipei (TW)

Correspondence Address: MERCHANT & GOULD PC, P.O. BOX 2903, MINNEAPOLIS, MN, 55402-0903, US

(73) Assignee: HannStar Display Corp.

(21) Appl. No.: 10/230,590

(22) Filed: Aug. 29, 2002

(30) Foreign Application Priority Data
Jun. 20, 2002 (TW) 091113431

(51) Int. Cl. G02F 1/1337

(52) U.S. Cl. 349/123; 349/130

(57) ABSTRACT

A liquid crystal display has a pair of transparent substrates disposed opposite to each other sandwiching a liquid crystal layer therebetween, and the liquid crystal layer comprises a plurality of liquid crystal molecules and chiral components. A plurality of scanning electrodes and signal electrodes are patterned on the first substrate to define a plurality of pixel areas, wherein each pixel area has a first area and a second area. A plurality of switching devices are formed on the plurality of pixel areas and connected to the scanning electrodes, the signal electrodes and the pixel electrodes. A protrusive structure with a plurality of protrusions formed in each pixel area to generate a pretilt angle for liquid crystal molecules.

### BACKGROUND OF THE INVENTION

1. Field of the Invention

The present invention relates to a liquid crystal display and, more particularly, to a liquid crystal display with wide view angle and high brightness uniformity.

2. Description of the Related Art

To obtain a high image quality as good as the traditional CRT display (Cathode Ray Tube display) in LCD (Liquid Crystal Display) for large-screen display products, many properties, such as high contrast ratio, fast response time and wide view angle, need to be improved. Therefore, many types of LCD, like MVA-LCD (Multi-domain vertical alignment LCD), ECB-LCD (electrically controlled birefringence-LCD) that can provides high contrast ratio, fast response time and wide view angle, are disclosed.

FIG. 1 is a top view showing a ECB-Liquid crystal display. FIG. 2 is a sectional view showing the structure along to line I-I of FIG. 1. A plurality of liquid crystal molecules 24 are held between color filter substrate 20 and TFT (thin film transistor) substrate 18 and are aligned vertically to the TFT substrate 18. A plurality of scanning electrodes 10 and a plurality of signal electrodes 12 are formed on the TFT substrate 18 to define a plurality of pixel areas 15 being arranged in a matrix form. A TFT device 14 and a plurality of block pixel electrode 16I are formed in each pixel area 15. The first alignment film 22I is deposited on the liquid crystal layer 24 side of the TFT substrate 18. A common electrode 16II is formed on the liquid crystal layer 24 side of the color filter substrate 20. The second alignment film 22II is deposited on the common electrode 16II. When applying the voltage to the common electrode 16II and the pixel electrode 16I, electric fields E are generated to drive the liquid crystal molecules 24 rotating. Therefore, BCE-LCD can improve viewing angle and response time.

However, the position of the disconnected line is easily affected by process in vertical alignment LCD. It will result in the brightness anuniform (multiformity) as FIG. 3.

### SUMMARY OF THE INVENTION

The object of the present invention is to provide a wide view angle LCD having uniform brightness. The brightness uniformity of the display is improved by a protrusion structure and slits which induce LC molecules toarrange at a pretilt angle.

A liquid crystal display has a pair of transparent substrates disposed opposite to each other sandwiching a liquid crystal layer therebetween, and the liquid crystal layer comprises a plurality of liquid crystal molecules and chiral components. A plurality of scanning electrodes and signal electrodes are patterned on the first substrate to define a plurality of pixel areas, wherein each pixel area has a first area and a second area. A plurality of switching devices are formed on the plurality of pixel areas and connected to the scanning electrodes, the signal electrodes and the pixel electrodes. A protrusive structure with a plurality of protrusions formed in each pixel area to produce the pretilt angle for liquid crystal molecules.

According to the present invention, LCD has infinite-domain in the pixel area by producing a protrusive structure to generate the fringe electrode field. LCD with infinite-domain has super wide view angle. At the same time, the position of the disconnected line is fixed on the protrusive structure or on the first area. It can successfully increase the brightness uniformity.

Moreover, because the present invention can be fabricated using normal TN manufacturing method, the process is simple and has high production yield that will decrease the manufacturing cost.

### BRIFE DESCRIPTION OF THE DRAWINGS

FIG. 1 is a top view showing a ECB-Liquid crystal display.

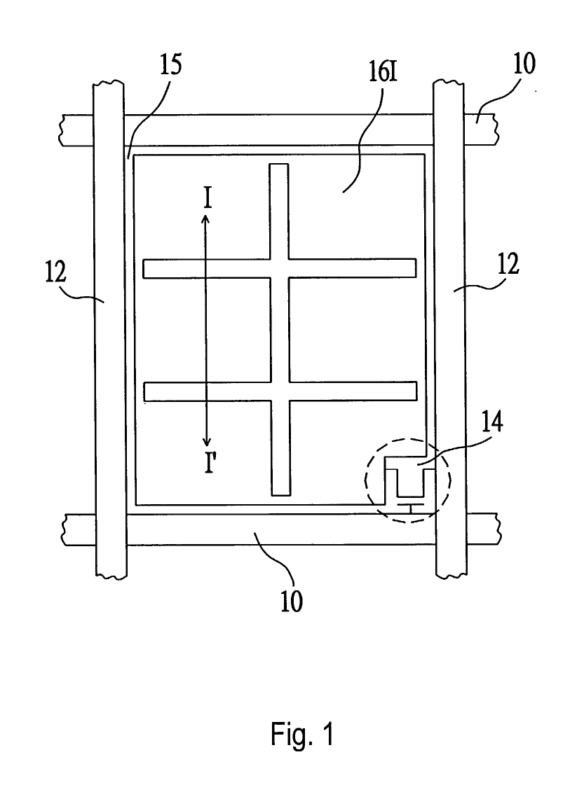

FIG. 2 is a sectional view showing the structure along to line I-I′ of FIG. 1.

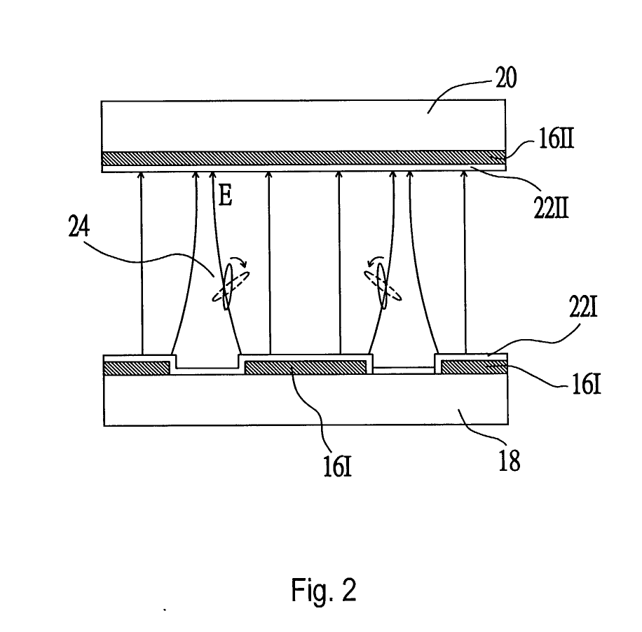

FIG. 3 is a diagram showing the image quality of a vertical alignment LCD.

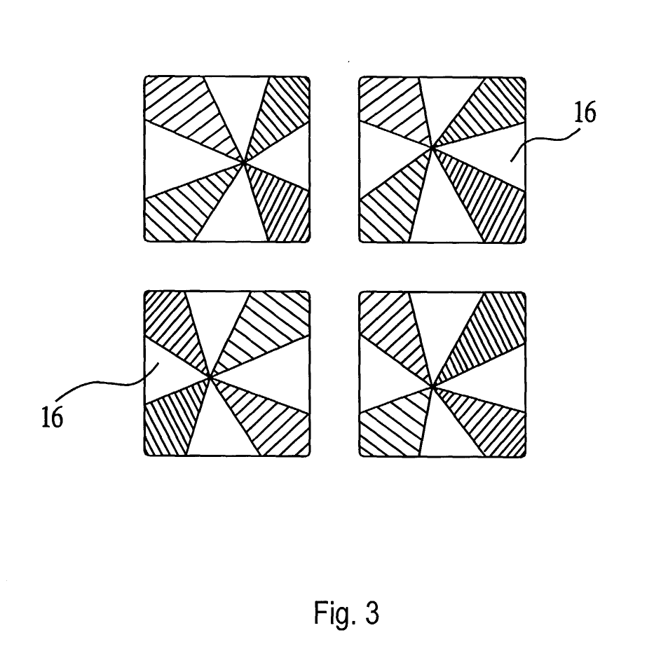

FIG. 4 is a top view showing a LCD according to first embodiment of the present invention.

FIG. 5 is a sectional view showing the structure along to line II-II′ of FIG. 4.

FIG. 6 is a diagram showing the image quality of a LCD of the present invention.

FIG. 7 is a top view showing a LCD according to second embodiment of the present invention.

FIG. 8 is a sectional view showing the structure along to line III-III′ of FIG. 7.

FIG. 9 is a top view showing a LCD according to third embodiment of the present invention.

FIG. 10 is a sectional view showing the structure along to line VI-VI′ of FIG. 9.

### DESCRIPTION OF THE PREFERRED EMBODIMENTS FIRST EMBODIMENT

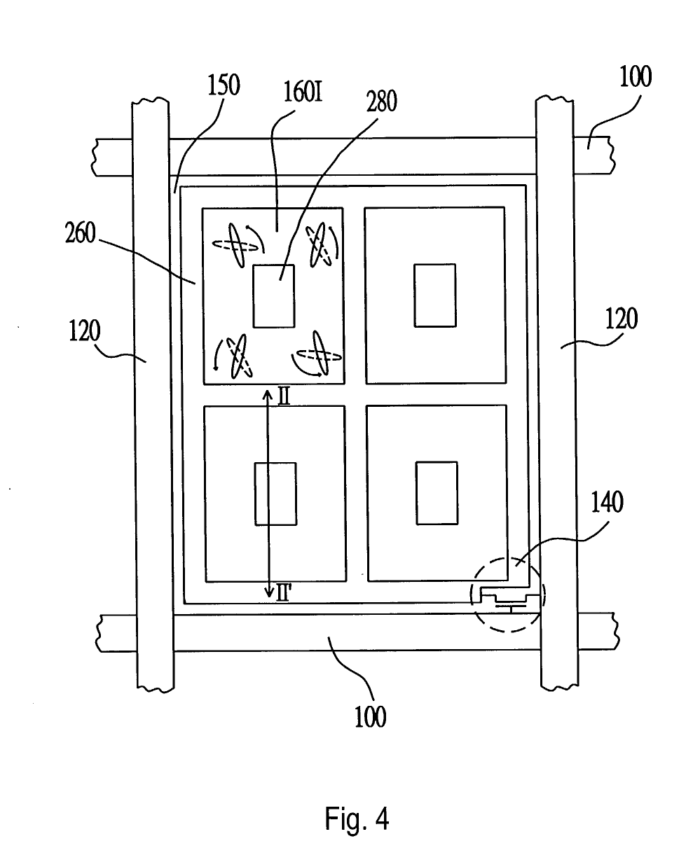

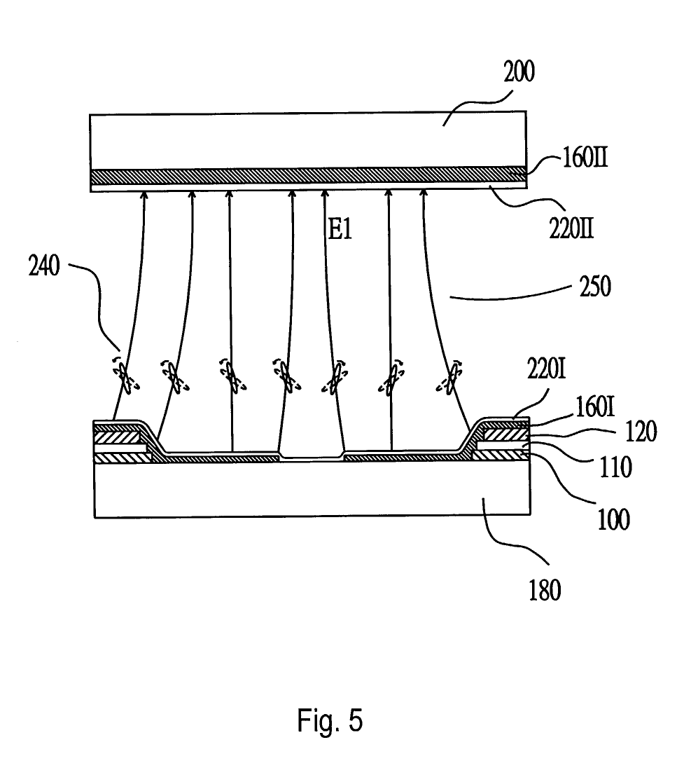

FIG. 4 is a top view showing a LCD according to the first embodiment of the present invention. FIG. 5 is a sectional view showing the structure along to line II-II′ of FIG. 4. On the lower insulating substrate 180, serving as a TFT array substrates 180, a plurality of scanning electrodes 100 are patterned and then covered by a gate insulating layer 110. Next, a plurality of signal electrodes 120 are patterned on the gate insulating layer 110. Thus, the scanning electrodes 100 and the signal electrodes 120 are arranged in a matrix form to define a plurality of pixel areas 150 which each of the pixel area 150 has a first area 280 and a second area. A plurality of pixel electrode 160I are formed on the second area of the plurality of pixel areas 150. A plurality of switching devices 140 are formed on the neighboring intersection of the scanning electrodes 100 and the signal electrodes 120 and are connected to the scanning electrodes 100, the signal electrodes 120 and the pixel electrodes 160I. The insulating substrate 180 is made of a material selected from a group comprising glass, quartz or the like. The scanning electrodes 100 and the signal electrodes 120 are made of non-transparent conductivity material, such as aluminum, tungsten, chromium, copper, and the combination thereof. The gate insulating layer 110 are made of transparent non-conductivity material, such as silicon nitride, silicon oxide, silicon oxynitride and the combination thereof. The pixel electrodes 160I are made of a transparent conductivity material, such as indium tin oxide (ITO), indium zinc oxide(IZO) or the like.

Moreover, the wall-shape protrusive structure 260 is formed on the pixel area 150 and are covered by the pixel electrodes 160I. The wall-shape protrusive structure 260 encircled the first area 280 in predetermined distance divides the pixel area 150 into a plurality of block regions. The height of the wall-shape protrusive structure 260 ranges from 0.6 to 1.0 um. The wall-shape protrusive structure 260 is stacked up by the non-transparent conductivity materials and the transparent non-conductivity materials. The non-transparent conductivity materials are formed simultaneaisly with the scanning electrodes 100 and signal electrodes 120. The transparent non-conductivity materials are formed simultaneaisly with the gate insulating layer 110. Thus, the production yield is not be decreased and the cost is lower because of no additional process step to form the wall-shape protrusive structure 260. Finally, a first alignment layer 220I of poly imide (PI) is formed on the liquid crystal layer 250 side of the lower insulating substrate 180.

On the upper insulating substrate 200, serving as a color filter substrates 200, a common electrode layer 160II are formed. Finally, a second alignment layer 220II of poly imide (PI) is formed on the liquid crystal layer 250 side of the upper insulating substrate 200. The common electrode layer 160II is made by transparent conductivity material, such as indium tin oxide (ITO), indium zinc oxide(IZO) or the like.

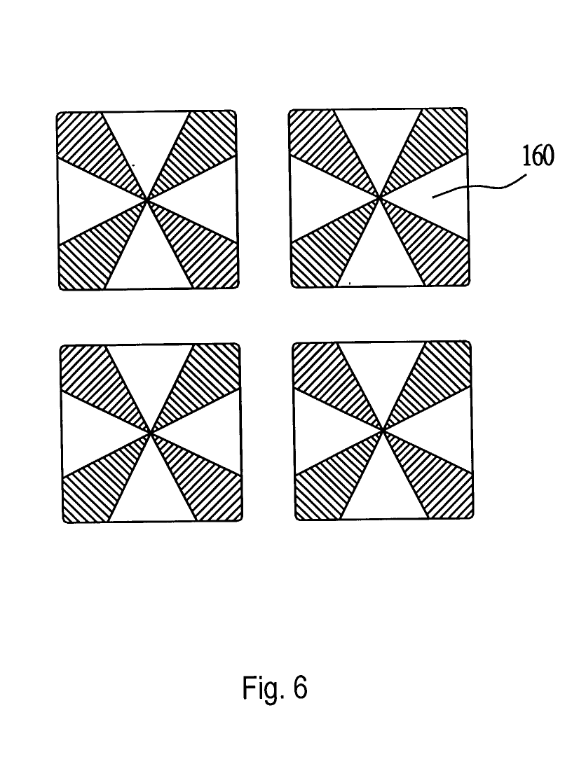

A liquid crystal layer 250 comprises a plurality of liquid crystal molecules 240 and chiral components (not shown) is held between the lower insulating substrate 180 and the upper insulating substrate 200. Liquid crystal molecules 240 are negative dielectric anisotropy material and are aligned vertically to the TFT substrate 180. When applying the voltage to the common electrode 160II and the pixel electrode 160I, as FIG. 5 shown, the electric fields are generated to drive liquid crystal molecules 240. The direction of the long axis of liquid crystal molecules 240 are vertical to the direction of the electric fields. Because of the fringe electrode field E₁ and the wall-shape protrusive structure 260, liquid crystal molecules 240 rotate in the predetermined direction in the Y-Z plane. At the same time, liquid crystal molecules 240 also rotate in the X-Y plane because of the chiral components (not shown). Liquid crystal molecules 240 tilt to pixel electrodes and counter-clockwise rotate simultaneously shown by arrow in FIG. 4. So that, liquid crystal molecules 240 can be aligned in 360 degree to form infinite-domain with the pixel area 150 to obtain super wide view angle. In FIG. 5, it is easy to observe the disconnection line of the liquid crystal molecules 240 between two adjacent wall-shape protrusion 260 appear in the first area 280. Thus, the disconnection line is successfully fixed in the first area 280, as show in FIG. 6, to improve the brightness uniformity.

### SECOND EMBODIMENT

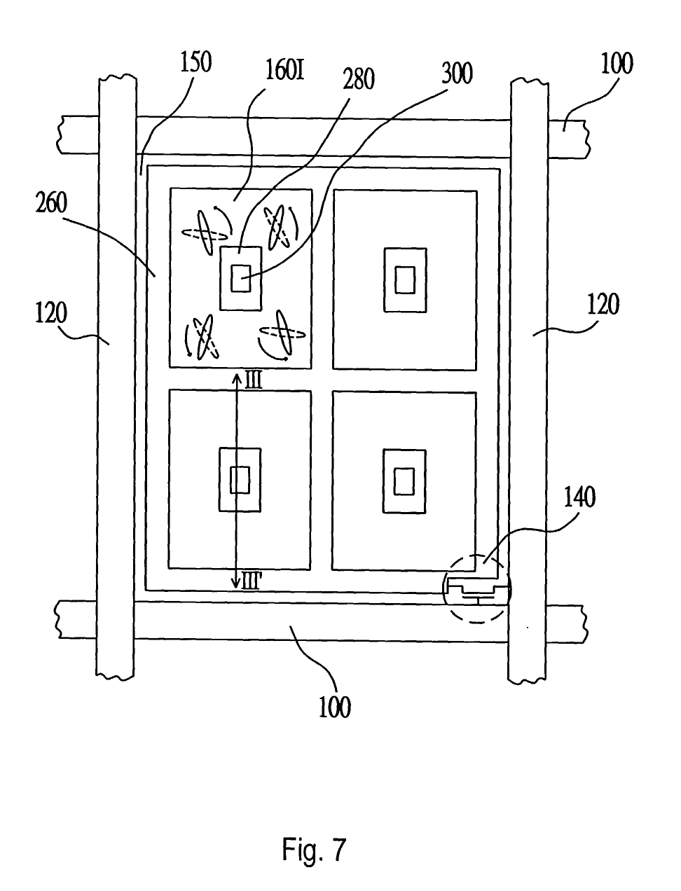

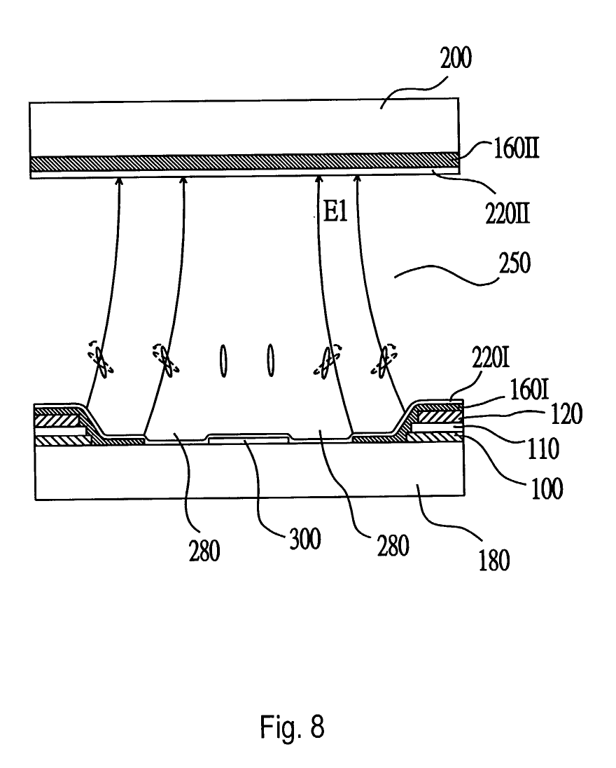

FIG. 7 is a top view showing a LCD according to second embodiment of the present invention. FIG. 8 is a sectional view showing the structure along to line III-III′ of FIG. 7. Comparing to the first embodimen of the present invention, a floating electrode 300 is formed in the center of the first area 280. A floating electrode 300 and the pixel electrode 160I are separated in the same plane. The design of second embodiment can achieve the same result as the first embodimen. The floating electrode is made of a transparent conductivity material, such as indium tin oxide (ITO), indium zinc oxide(IZO) or the like.

### THIRD EMBODIMENT

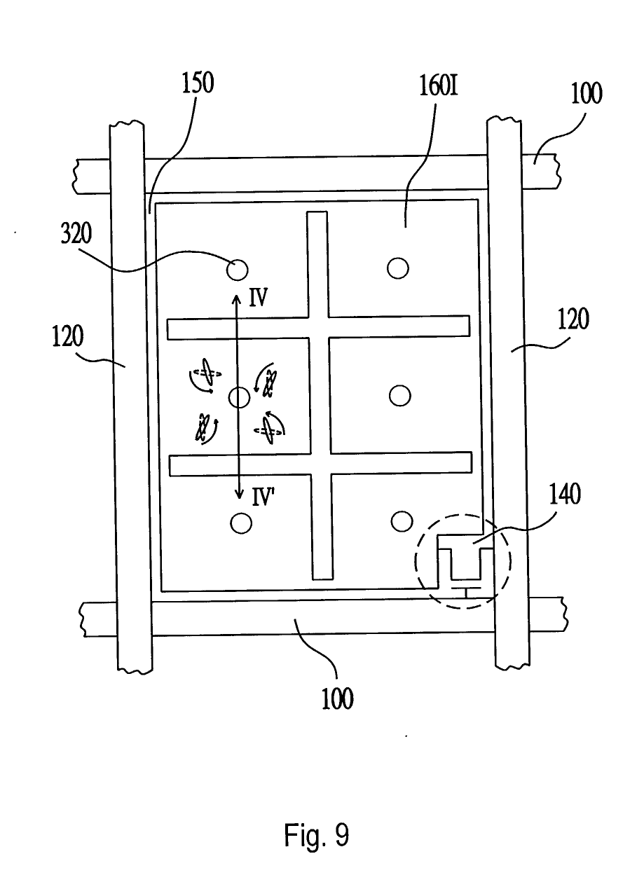

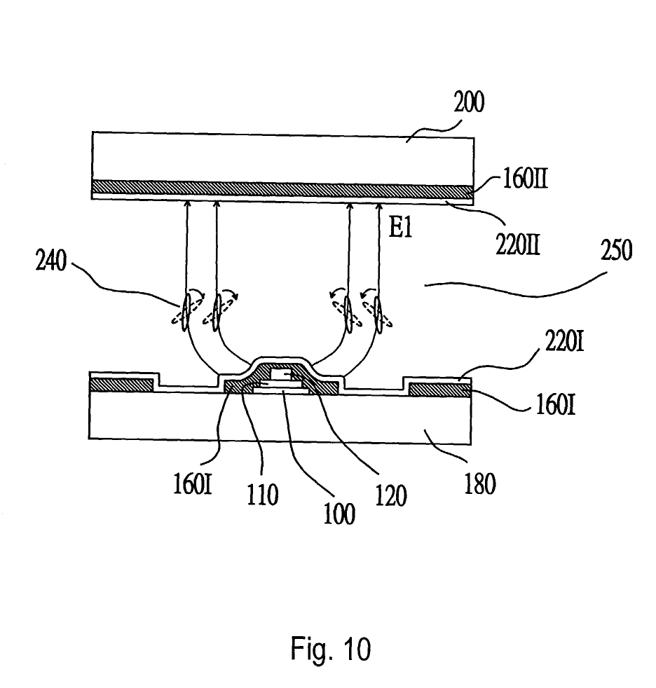

FIG. 9 is a top view showing a LCD according to the third embodiment of the present invention. FIG. 10 is a sectional view showing the structure along to line VI-VI′ of FIG. 9. Comparing to the first embodiment of the present invention, a plurality of block-shape pixel electrodes 160I are formed in the second area (not shown) of the pixel area 150. Each block-shape protrusion 320 is formed at the center of each block-shape pixel electrode 160I and is covered by the pixel electrode 160I. The height of the block-shape protrusions 320 ranges from 0.6 to 1.0 um. The block-shape protrusions 320 are stacked up by the non-transparent conductivity materials and the transparent non-conductivity materials. The non-transparent conductivity materials are formed simultaneaisly with the scanning electrodes 100 and signal electrodes 120. The transparent non-conductivity materials are formed simultaneaisly with the gate insulating layer 110. Therefore, the production yield is not be decreased and the cost is lower because of no additional process step to form the block-shape protrusions 320.

When applying the voltage to the common electrode 160II and the pixel electrode 160I, as show in FIG. 10, the electric fields are generated to drive liquid crystal molecules 240. The direction of the long axis of liquid crystal molecules 240 are perpendicular to the direction of the electric fields. Because of the fringe electrode field E₁ and the block-shape protrusions 320, liquid crystal molecules 240 rotate in the predetermined direction in the Y-Z plane. At the same time, liquid crystal molecules 240 also rotate in the X-Y plane because of the chiral components (not shown). Liquid crystal molecules 240 tilt to pixel electrodes and counterclockwise rotate simultaneously shown by arrow in FIG. 9. In FIG. 10, it is easy to observe the disconnection line of the liquid crystal molecules 240 on the block-shape pixel electrodes 160I appears at the protrusions 320. Thus, each disconnection line is successfully fixed at the center of each block-shape pixel electrode 160I, as show in FIG. 6, to improve the brightness uniformity.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display with wide view angle and high brightness uniformity, comprising:
a first substrate;
a second substrate;
a liquid crystal layer, held between said first substrate and said second substrate, said liquid crystal layer comprising a plurality of liquid crystal molecules and chiral components;
a plurality of scanning electrodes and a plurality of signal electrodes patterned on said first substrate for defining a plurality of pixel areas, wherein each of the plurality of pixel areas has a first area and a second area;
a plurality of pixel electrodes formed on said second areas of said pixel areas;
a plurality of switching devices formed on said plurality of pixel areas, said switching devices being connected to said scanning electrodes, said signal electrodes and said pixel electrodes; and
a plurality of protrusive structures, each of the plurality of protrusive structures having a plurality of protrusions and being formed on each of the plurality of pixel areas, to induce said liquid crystal molecules to arrange at a pretilt angle.

2. The liquid crystal display according to claim 1, wherein said first substrate is an insulation substrate.

3. The Liquid crystal display according to claim 1, wherein said second substrate is a color filter substrate.

4. The Liquid crystal display according to claim 1, wherein said second substrate further comprises a common electrode layer formed on a surface of said second substrate.

5. The Liquid crystal display according to claim 1, wherein said scanning electrodes and said signal electrodes are made of non-transparent conductivity materials.

6. The Liquid crystal display according to claim 5, wherein said non-transparent conductivity materials are selected from a group essentially consisting of aluminum, tungsten, chromium, copper, and the combination thereof.

7. The Liquid crystal display according to claim 1, wherein said liquid crystal molecule is made of a negative dielectric constant anisotropy material.

8. The Liquid crystal display according to claim 1, wherein said liquid crystal molecule is in vertical alignment.

9. The Liquid crystal display according to claim 1, wherein said first area is patterned as at least one slit extending along at least one direction for dividing said pixel electrode into a plurality of block-shape pixel electrodes.

10. The Liquid crystal display according to claim 1, wherein said first area is patterned as at least one of block-shape.

11. The Liquid crystal display according to claim 1, wherein a floating electrode is formed on said first area.

12. The Liquid crystal display according to claim 11, wherein said floating electrode and said pixel electrode are formed separatly on a same plane.

13. The Liquid crystal display according to claim 11, wherein said floating electrode is made of transparent conductivity materials.

14. The Liquid crystal display according to claim 1, wherein said pixel electrode is made of transparent conductivity materials.

15. The Liquid crystal display according to claim 13, wherein said transparent conductivity materials are selected from a group essentially consisting of indium tin oxide (ITO), indium zinc oxide(IZO) and the like.

16. The Liquid crystal display according to claim 14, wherein said transparent conductivity materials are selected from a group essentially consisting of indium tin oxide (ITO), indium zinc oxide(IZO) and the like.

17. The Liquid crystal display according to claim 1, wherein said protrusive structure is patterned as a wall-shape protrusion, encircled said first area in a predetermined distance for dividing said pixel area into a plurality of block regions.

18. The Liquid crystal display according to claim 9, wherein said protrusive structure is patterned as a block-shape protrusion and formed at the center of each of the plurality of said block-shape pixel electrodes.

19. The Liquid crystal display according to claim 1, wherein said protrusive structures are covered by a corresponding pixel electrode.

20. The Liquid crystal display according to claim 1, wherein said protrusive structures are made of non-transparent conductivity materials and non-conductivity materials.

21. The Liquid crystal display according to claim 20, wherein said non-transparent conductivity materials are selected from a group essentially consisting of aluminum, tungsten, chromium, copper, and the combination thereof.

22. The Liquid crystal display according to claim 20, wherein said non-conductivity materials are selected from a group essentially consisting of silicon nitride, silicon oxide, silicon oxynitride and the combination thereof.

23. A liquid crystal display with wide view angle and high brightness uniformity, comprising:
a first substrate;
a second substrate;
a liquid crystal layer, held between said first substrate and said second substrate, said liquid crystal layer comprising a plurality of liquid crystal molecules and chiral components;
a plurality of scanning electrodes and a plurality of signal electrodes, patterned on said first substrate to define a plurality of pixel areas, wherein each of the plurality of pixel areas has a first area and a second area;
a plurality of pixel electrodes formed on said second areas of said pixel areas;
a plurality of switching devices formed on said plurality of pixel areas, said switching devices being connected to said scanning electrodes, said signal electrodes and said pixel electrodes; and
a plurality of wall-shape protrusive structures, each of the plurality of wall-shape protrusive structures formed on each of the plurality of pixel areas for dividing each of the plurality of pixel areas into a plurality of block regions.

24. The Liquid crystal display according to claim 23, wherein said scanning electrodes and said signal electrodes are made of non-transparent conductivity material.

25. The Liquid crystal display according to claim 23, wherein said liquid crystal molecule is made of a negative dielectric constant anisotropy material.

26. The Liquid crystal display according to claim 23, wherein said liquid crystal molecule is in vertical alignment.

27. The Liquid crystal display according to claim 23, wherein a floating electrode formed on said first area.

28. The Liquid crystal display according to claim 27, wherein said floating electrode and said pixel electrode are formed separately on a same plane.

29. The Liquid crystal display according to claim 27, wherein said floating electrode is made of transparent conductivity materials.

30. The Liquid crystal display according to claim 23, wherein each of the plurality of protrusive structures is covered by a corresponding pixel electrode.

31. The Liquid crystal display according to claim 23, wherein said protrusive structure is made of non-transparent conductivity material and non-conductivity material.

32. A liquid crystal display with wide view angle and high brightness uniformity, comprising:
a first substrate;
a second substrate;
a liquid crystal layer, held between said first substrate and said second substrate, said liquid crystal layer comprising a plurality of liquid crystal molecules and chiral components;
a plurality of scanning electrodes and a plurality of signal electrodes patterned on said first substrate to define a plurality of pixel areas;
a plurality of liquid crystal molecules controlling devices formed on said plurality of pixel areas; and
a plurality of protrusions formed on each of the plurality of pixel areas for fixing at least one disconnection line;
whereby the at least one disconnection line is fixed, the brightness uniformity is improved.

33. The Liquid crystal display according to claim 32, wherein said second substrate is a color filter substrate.

34. The Liquid crystal display according to claim 32, wherein said liquid crystal molecule is in vertical alignment.

35. The Liquid crystal display according to claim 32, wherein said liquid crystal molecules controlling devices further comprising:
a plurality of block-shape pixel electrodes, formed on said pixel area; and
a thin film transistor connected to said scanning electrodes, said signal electrodes and said pixel electrodes.

36. The Liquid crystal display according to claim 35, wherein said protrusion is formed at the center of each of the plurality of block-shape pixel electrodes.

37. The Liquid crystal display according to claim 32, wherein each of the plurality of protrusions is covered by a corresponding pixel electrode.

38. The Liquid crystal display according to claim 32, wherein each of the plurality of protrusions is made of non-transparent conductivity materials and non-conductivity materials.
